(19) United States
(12) Patent Application Publication
(10) Pub. No.: US 2011/0064046 A1
(43) Pub. Date: Mar. 17, 2011

(54) User plane emergency location continuity for voice over internet protocol (VoIP)/IMS emergency services

(76) Inventor: Yinjun Zhu, Sammamish, WA (US)

(21) Appl. No.: 12/585,348

(22) Filed: Sep. 11, 2009

(51) Int. Cl. H04W 36/00

(52) U.S. Cl. 370/331

(57) ABSTRACT

Continuity of location information relating to an IMS emergency call during their IMS emergency call is maintained by triggering, during an IMS emergency call, a request to a location service based on an occurrence of a handover of an IMS emergency calling mobile device. A physical user plane location server initiates a user plane positioning request, and an updated location of the IMS emergency call is obtained during the IMS emergency call but after the handover. Updated location information relating to an IMS emergency caller is kept track of during IMS handover during their IMS emergency call by mapping access network information relating to a mobile IMS emergency calling device. Coverage information relating to a plurality of location servers is maintained, and a currently serving location server is associated with an updated location of the IMS emergency caller as the IMS emergency caller changes location during an IMS emergency call.

### BACKGROUND OF THE INVENTION

1. Field of the Invention

This invention relates generally to wireless and long distance carriers, Internet Service Providers (ISPs), and information content delivery services/providers and long distance carriers. More particularly, it relates to location services for the wireless industry. In terms of access technologies, this invention is related to the following access types, though not limited thereto:
Wireless LAN (WLAN) that is built based on IEEE 802.11x;
Wireless Personal Area Network (WPAN) that is built based on IEEE 802.15 (also referred to as BlueTooth);
Worldwide Interoperability for Microwave Access (WiMAX) or Wireless metropolitan area network (WMAN), which is built based on IEEE 802.16;
3G packet data access technologies based on UMTS or 1xEVDO, or the enhanced technologies, e.g. High Speed Downlink Packet Access (HSDPA);
“4G” packet data access based on Long Term Evolution (LTE)
Packet Data Access over Satellite (don't have information what standards are applicable);
High speed packet data access over speed point-to-point optical link, e.g. built based on IEEE 802.17.

2. Background of Related Art

911 is a phone number widely recognized as an emergency phone number that is used by emergency dispatch personnel, among other things, to determine a location of a caller. Enhanced 911 (E911) is defined by the transmission of callback number and location information. E911 may be implemented for landline and/or mobile devices.

Some Public Safety Answering Points (PSAPs) are not enhanced, and thus do not receive the callback or location information from any phone, landline or mobile.

Voice Over IP (VoIP) is a technology that has been developed as an alternative telephony technology to the conventional telephony service (e.g. PSTN). VoIP takes advantage of high speed Internet data switched networks, and is able to provide low cost telephony services to end users. VoIP technology emulates a phone call, but instead of using a circuit based system such as the telephone network, utilizes packetized data transmission techniques most notably implemented in the Internet.

Location information regarding subscribers or subscribers' individual devices is becoming increasingly available in a wireless network. Location information relates to absolute coordinates of a wireless device.

There are two basic types of location service architectures available for wireless networks, User Plane location service architecture and Control Plane location service architecture. Same solutions are also recognized applicable in standards (i.e. WiMAX Forum, 3GPP and 3GPP2) for emergency location services.

FIG. 3 shows a conventional LoCation Services (LCS) request.

In particular, as shown in FIG. 3, a location server 106 requests location information regarding a particular mobile subscriber (MS) from a core network node, e.g., from a Mobile Switch Center (MSC) 110. Requested information regarding a particular wireless device (MS) may include, e.g., precise location of the MS, coarse location based on the serving cell or other network element identifiers. The location server 106 may also request information regarding the wireless device such as precise location of the MS, coarse location based on the serving cell or other network element identifiers from a Packet Data Node (e.g., SGSN, GGSN, or PDSN), or help the device calculate x/y (lat/lon) direction. Typically, location information regarding a particular wireless device is requested of a location server.

As shown in step 1 of FIG. 3, a location services client 104 sends a message to a location server 106.

In step 2, the location server 106 sends a Send Routing Information for LCS message to a Home Location Register 108, requesting subscriber information regarding a particular subscriber.

In step 3, the carrier's Home Location Register (HLR) 108 provides the subscriber information for the requested subscriber back to the location server 106.

In step 4, location information regarding the requested subscriber is requested to either an MSC or Packet Data node 110. The Radio Access Network (RAN), via the MSC or Packet Data Node, preferably provides precise location information using, e.g., a satellite-based global positioning system (e.g., GPS), triangulation techniques, or other relevant locating technology, or optionally helps the device calculate X/Y (lat/lon) direction.

In step 5, the location request is forwarded to the Radio Access Network (RAN) 112 if needed.

In step 6, precise, updated location information regarding the requested subscriber is sent to the location server (LS) 106.

In step 7, an ultimate response to the original location request is sent to the LCS client 104 that initially requested the location information.

Secure User Plane for Location (SUPL) is a standards-based protocol that has been developed to allow a mobile handset client to communicate with a location server, e.g., as shown in step 1 of FIG. 3. The SUPL specification is defined by the Open Mobile Alliance (OMA) standards working group. Refer to OMA Secure User Plane Location Architecture document, OMA-AD-SUPL-V1_{—}0-20060127-C for more details on OMA SUPL call flows; and OMA User Plane Location Protocol document, OMA-TS-ULP-V1_{—}0-20060127-C. The OMA SUPL Version 1 specifies two basic types of call flows: (1) a SUPL network initiated (NI) call flow, and (2) a SUPL set initiated (SI) call flow. According to the SUPL standard, a session ID has a unique value consisting of server and handset portions.

FIG. 4 shows conventional OMA mobile terminated call flow for a SUPL location request initiated by a SUPL agent.

In particular, as shown in FIG. 4, messages are passed between a SUPL agent 802 residing in the network, a satellite information reference server 804, a SUPL server 806, a push proxy gateway (PPG) 808, and a SUPL terminal (SET) 812.

The SUPL server (or SUPL location platform (SLP)) 806 comprises a SUPL location center (SLC) and SUPL positioning center (SPC). A mobile device is generalized in FIG. 4 as a SUPL enabled terminal (SET) 812. The SLC coordinates operations of SUPL communications in the network, and controls the SPC component. The SPC Provides global positioning system (GPS) assistance data to the SUPL enabled terminal (SET) 812, and may perform precise position calculation of a SET 812.

Network initiated location requests 820 arrive at the SUPL server 806 via an MLP interface. The SUPL server 806 processing this network initiated request is required to send a trigger message (SUPL INIT message) 822, via the PPG 808, to the SET 812 for validating and ultimately initiating a SUPL positioning session 828. The trigger message 822 is sent to the SET 812 as a push message 824 from the PPG 808 (or as an SMS message from an SMSC/MC). At that point, the SET 812 establishes a secure TCP/IP connection 828 to the SUPL server 806 to respond to the SUPL positioning request.

For network initiated end-to-end IP based location services, when a location server needs to find out contact information (e.g. an IP address) of a given target, the location server sends a trigger to the target to allow the target to establish a session with the location server. Conventional IP based user plane location services (e.g., OMA SUPL) are built upon WAP Push/SMS messaging and TCP as a transport protocol for initiating a mobile terminating positioning procedure.

It is the case that there are some scenarios where conventional use of User Plane Location Services does not work well or does not work at all.

An example relates to Voice over IP (VoIP) based emergency calling (there are some variances in the wireless industry, e.g., IMS emergency in the 3GPP standard and MMD emergency in the 3GPP2 standard, and referred to generally as a SIP call by the IETF.) This scenario depicts an emergency call which has already established a SIP session with the serving network. During the emergency call, the appropriate Public Safety Answering Point (PSAP) may require updated location information relating to the emergency caller.

As new wireless technologies become available, higher packet data bandwidth can be provided (e.g. LTE access and WiMAX), and Voice over IP (VoIP, or Internet Protocol (IP) Multimedia Core Network Subsystem (IMS) defined for wireless networks) over wireless packet data networks can become available to wireless consumers.

When IMS service is ultimately deployed, emergency services must also be provided. But just like in an in-circuit switched wireless network, the requirements of emergency location services will be regulated.

For instance, one of the key characteristics of wireless communication is its mobility, not only for roaming accessibility but also for handover for service continuity.

When an IMS emergency call is involved in handover, emergency location service continuity associated with the IMS emergency call should also be supported. In a control plane solution, location continuity is natively built upon the underlying signaling of the access networks, therefore the handover related information from the access network is available and makes emergency location service continuity possible.

FIG. 5 shows conventional support of emergency location continuity during IP Multimedia Subsystem (IMS) emergency call handover from packet services (PS) to PS, where user plane location is used before an IMS handover occurs.

In particular, as shown in FIG. 5, a source network of an emergency call requiring a call handover utilizes wireless packet data access, i.e., PS, and a target network of the call handover utilizes wireless packet data access, i.e., PS. In such a case, emergency location service continuity is adequately maintained during an IMS handover, unless the handover crosses the coverage area of the serving user plane (UP) location server. When the IMS emergency caller moves out of the coverage of the UP location server, the responding public service answering point (PSAP) generates a request for an updated location of the emergency caller. In such a case, the location retrieval function (LRF) needs to query the corresponding location server that serves the target location area.

In step 1 of FIG. 5, a VoIP/IMS capable mobile 501 initiates an IMS emergency call. The call is routed to the Emergency Proxy (e.g. E-CSCF per 3GPP TS 23.167) 503.

In step 2, the Emergency Proxy/E-CSCF 503 queries the Location Retrieval Function (LRF)/User Plane Location Server 505 for emergency call routing instruction by providing the location information of the emergency caller 501.

In step 3, upon receiving the call routing instruction from the LRF/User Plane Location Server 505, the Emergency Proxy/E-CSCF 503 routes the IMS emergency call to the corresponding PSAP 507.

In steps 4 and 5, the PSAP 507 queries the location of the emergency caller 501 using the routing key (ESQK).

In step 6, the User Plane Location Server/LRF 505 initiates a user plane positioning procedure towards the IMS emergency caller 501.

In steps 7 and 8, the updated location of the IMS emergency caller 501 is returned to the PSAP 507.

FIG. 6 shows conventional support of emergency location continuity during IP Multimedia Subsystem (IMS) emergency call handover from packet services (PS) to circuit services (CS), where user plane location is used before an IMS handover occurs.

In particular, as shown in FIG. 6, a source network of an emergency call requiring a call handover utilizes wireless packet data access, i.e., PS, and a target network of the call handover utilizes wireless circuit switched access, i.e., CS. In such a case, when Voice Call Continuity (VCC) is supported, an IMS emergency call may be handed over to a legacy circuit switched cellular network (CS). In this case, the PSAP anchor point location retrieval function (LRF) needs to query the corresponding Gateway Mobile Location Center (GMLC)/Mobile Positioning Center (MPC) of the target cellular network.

In step 1 of FIG. 6, a VoIP/IMS capable mobile 601 initiates an IMS emergency call. The IMS emergency call is routed to the Emergency Proxy (e.g. E-CSCF per 3GPP TS 23.167) 603.

In step 2, the Emergency Proxy/E-CSCF 603 queries the LRF/User Plane Location Server 605 for emergency call routing instruction by providing the location information of the IMS emergency caller 601.

In step 3, upon receiving the call routing instruction from the LRF/User Plane Location Server 605, the Emergency Proxy/E-CSCF 603 routes the IMS emergency call to the corresponding PSAP 607.

In steps 4 and 5, the PSAP 607 queries the location of the emergency caller 601 using the routing key (ESQK).

In step 6, the User Plane Location Server/LRF 605 initiates a user plane positioning procedure towards the IMS emergency caller 601.

In steps 7 and 8, the updated location of the IMS emergency caller is returned to the PSAP 607.

The User Plane solution, however, is independent from underlying access networks, thus making it difficult to support emergency location service continuity in some handover scenarios.

### SUMMARY OF THE INVENTION

In accordance with the principles of the present invention, a method of maintaining continuity of location information relating to an IMS emergency caller during their IMS emergency call, comprises triggering, during an Internet Protocol Multimedia Subsystem (IMS) emergency call, a request to a location service based on an occurrence of a handover of an IMS emergency calling mobile device. A physical user plane location server initiates a user plane positioning request, and an updated location of the IMS emergency call is obtained during the IMS emergency call but after the handover.

A method of keeping track of updated location information relating to an IMS emergency caller during handover in accordance with another aspect of the invention comprises mapping access network information relating to a mobile Internet Protocol Multimedia Subsystem (IMS) emergency calling device. Coverage information relating to a plurality of location servers is maintained. A currently serving location server is associated with an updated location of the IMS emergency caller as the IMS emergency caller changes location during a given IMS emergency call.

### BRIEF DESCRIPTION OF THE DRAWINGS

Features and advantages of the present invention will become apparent to those skilled in the art from the following description with reference to the drawings, in which:

FIG. 1 provides high level description of emergency location service continuity during packet services (PS) to PS handover of VoIP/IMS emergency call, in accordance with the principles of the present invention.

FIG. 2 provides high level description of emergency location service continuity during PS to circuit services (CS) handover of VoIP/IMS emergency call, in accordance with the principles of the present invention.

FIG. 3 shows a conventional LoCation Services (LCS) request.

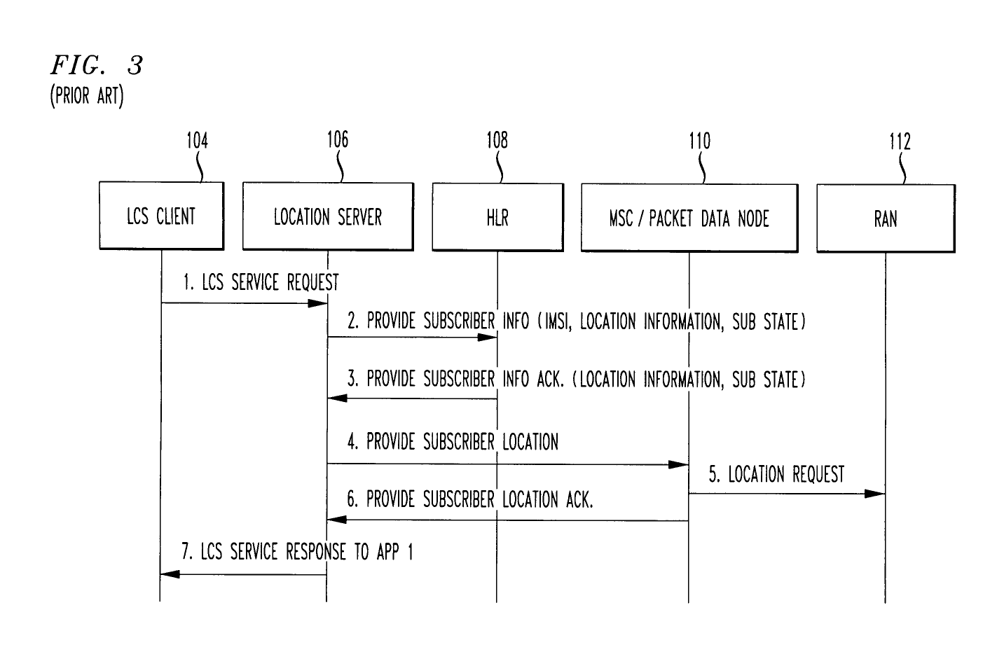

FIG. 4 shows conventional OMA mobile terminated call flow for a SUPL location request initiated by a SUPL agent.

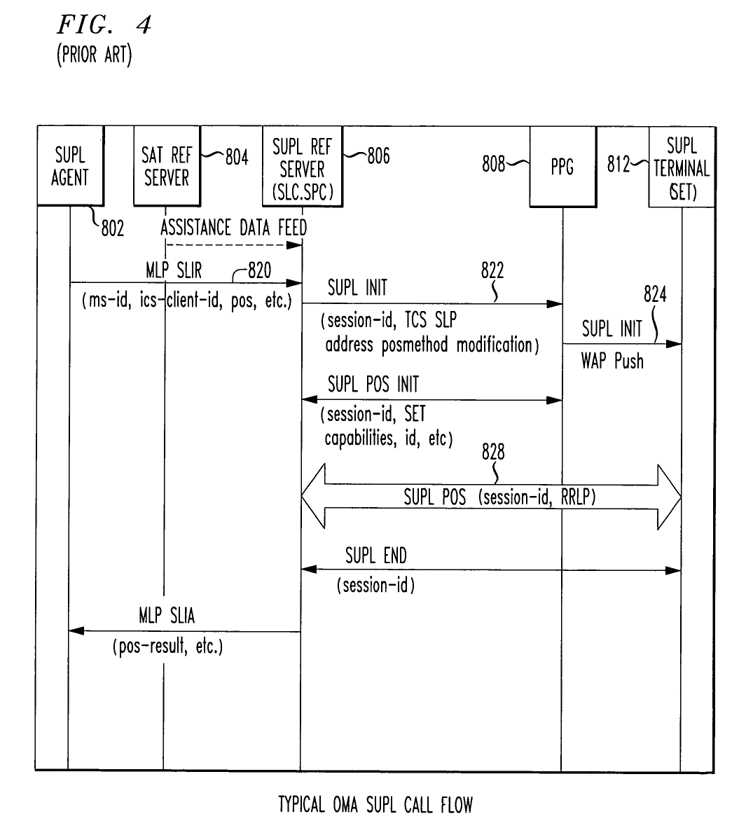

FIG. 5 shows conventional support of emergency location continuity during IP Multimedia Subsystem (IMS) emergency call handover from packet services (PS) to PS, where user plane location is used before an IMS handover occurs.

FIG. 6 shows conventional support of emergency location continuity during IP Multimedia Subsystem (IMS) emergency call handover from packet services (PS) to circuit services (CS), where user plane location is used before an IMS handover occurs.

### DETAILED DESCRIPTION OF ILLUSTRATIVE EMBODIMENTS

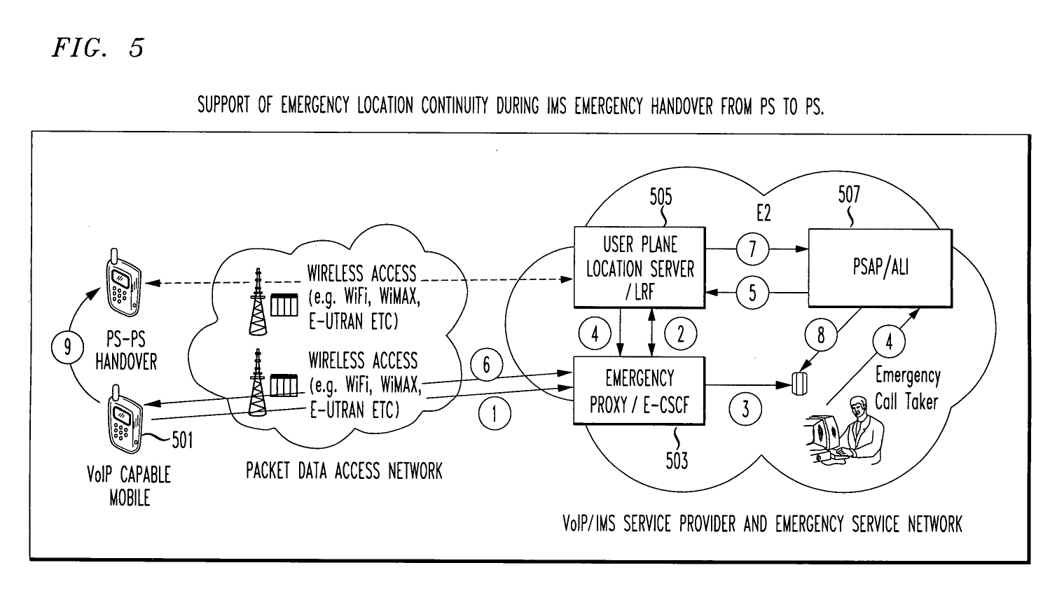

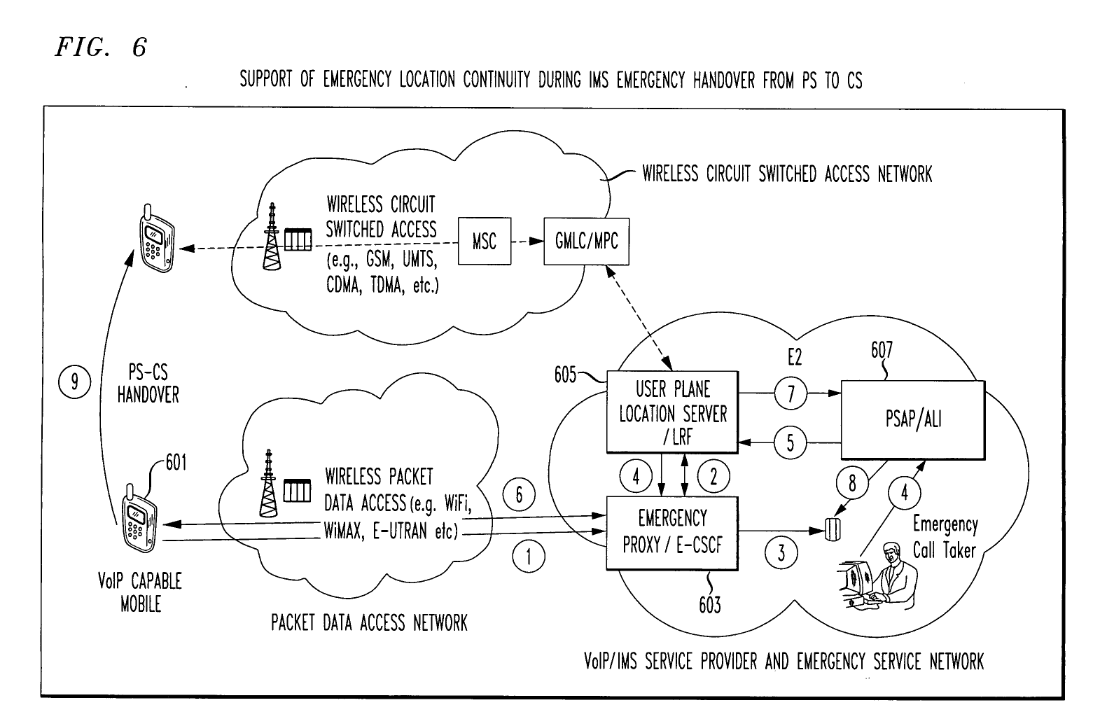

The present inventor has appreciated that in the scenarios outlined in FIGS. 5 and 6, to better support location service continuity for IMS emergency handovers, there are gaps in the standards.

The present invention provides a solution to allow location service continuity when user plane location service is used for IMS/VoIP emergency services.

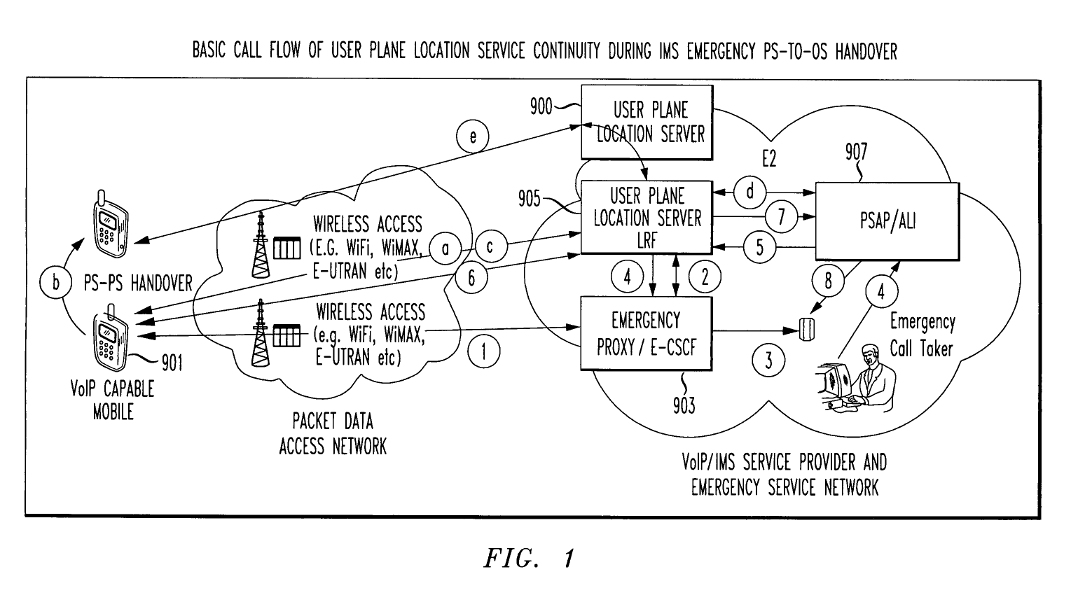

FIG. 1 provides high level description of emergency location service continuity during packet services to packet services (PS-PS) handover of VoIP/IMS emergency call, in accordance with the principles of the present invention.

In particular, FIG. 1 shows exemplary basic call flow of User Plane location service continuity during IMS emergency PS-to-PS handover, in accordance with the principles of the present invention.

The general service description depicted in FIG. 1 is illustrated as following:

In step 1 of FIG. 1, a VoIP/IMS capable mobile 901 initiates an IMS emergency call. The IMS emergency call is routed to an Emergency Proxy (e.g. E-CSCF per 3GPP TS 23.167) 903.

In step 2, the Emergency Proxy/E-CSCF 903 queries a Location Retrieval Function (LRF)/User Plane Location Server 905 for emergency call routing instruction by providing the location information of the IMS emergency caller 901.

In step 3, upon receiving the call routing instruction from the LRF/User Plane Location Server 905, the Emergency Proxy/E-CSCF 903 routes the IMS emergency call to the corresponding PSAP 907.

In steps 4 and 5, the PSAP 907 queries the location of the IMS emergency caller using a routing key (ESQK).

In step 6, the User Plane Location Server/LRF 905 initiates a user plane positioning procedure towards the IMS emergency caller 901.

In steps 7 and 8, the updated location of the IMS emergency caller 901 is returned to the PSAP 907.

In addition to these otherwise conventional steps, the invention provides the additional steps:

In step (a), a physical User Plane Location Server 900 initiates an event trigger location service request to the emergency caller's mobile 901. The event trigger requires the mobile 901 to report access network information to the serving User Plane Location Server 900 whenever the mobile 901 performs a handover.

In step (b), the mobile 901 performs a handover for some reason, e.g., due to a change of radio reception conditions, moving out of a coverage range of the User Plane Location Server, etc.

In step (c), the mobile 901 initiates a user plane (UP) event location report to the serving User Plane Location Server 900. The User Plane Location Server 900 stores the access network information to records associated with the IMS emergency call.

In step (d), the PSAP 907 request for updated location of the IMS emergency caller 901.

In step (e) of FIG. 1, based on the cached access network information associated with the IMS emergency call and the mapping of the service coverage of individual User Plane Location Servers 900 and access network information, the original User Plane Location Server/LRF 905 initiates a user plane location service request for an updated location of the IMS emergency caller 901.

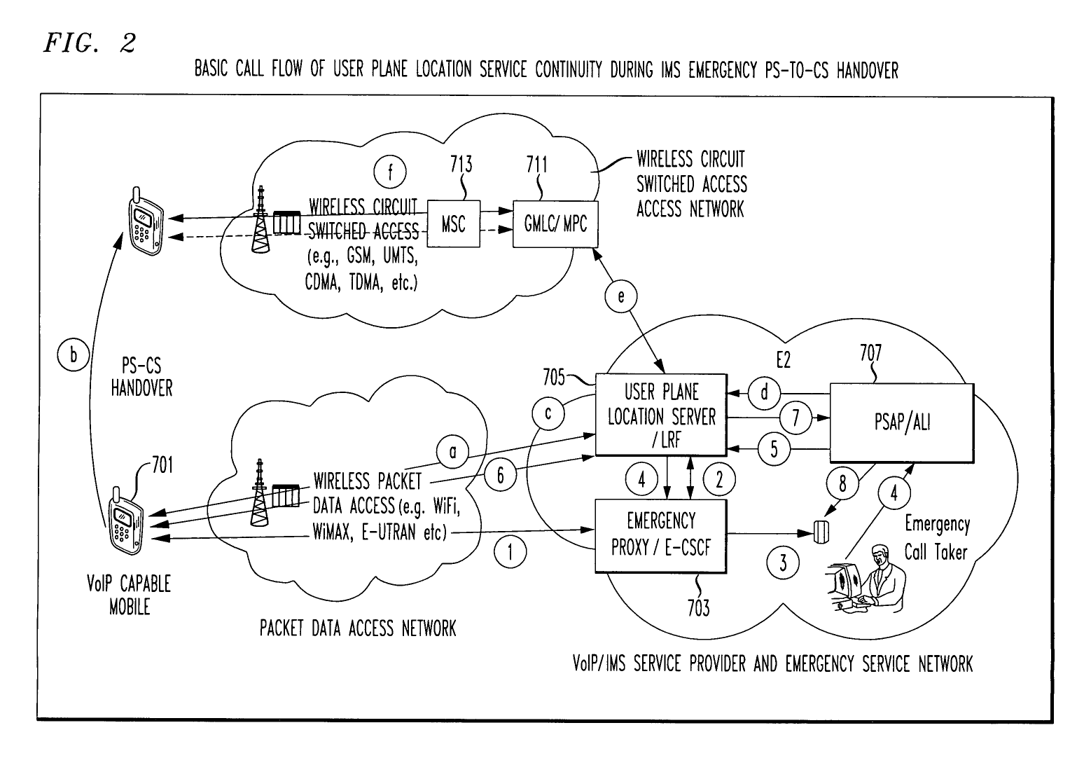

FIG. 2 provides high level description of emergency location service continuity during packet services to circuit services (PS-CS) handover of VoIP/IMS emergency call, in accordance with the principles of the present invention.

In particular, FIG. 2 shows exemplary basic call flow of User Plane location service continuity during IMS emergency PS-to-CS handover.

The general service description depicted in FIG. 2 is illustrated as following:

In step 1 of FIG. 2, a VoIP/IMS capable mobile 701 initiates an IMS emergency call. The IMS emergency call is routed to an Emergency Proxy (e.g. E-CSCF per 3GPP TS 23.167) 703.

In step 2, the Emergency Proxy/E-CSCF 703 queries an LRF/User Plane Location Server 705 for IMS emergency call routing instruction by providing location information of the IMS emergency caller 701.

In step 3, upon receiving the call routing instruction from the LRF/User Plane Location Server 705, the Emergency Proxy/E-CSCF 703 routes the IMS emergency call to the corresponding PSAP 707.

In steps 4 and 5, the PSAP 707 queries the location of the IMS emergency caller 701 using a routing key (ESQK).

In step 6, the User Plane Location Server/LRF 705 initiates a user plane positioning procedure towards the IMS emergency caller 701.

In steps 7 and 8, an updated location of the IMS emergency caller 701 is returned to the PSAP 707.

In addition to these otherwise conventional steps, the invention provides the additional steps:

In step (a), the User Plane Location Server 705 initiates an event trigger location service request to the emergency caller's mobile 701. The event trigger requires the mobile 701 to report its access network information to a serving User Plane Location Server 705 whenever the mobile 701 performs a handover.

In step (b), the mobile 701 performs a handover, e.g., due to changes in radio reception conditions, and/or a switch of voice service from a packet switched IMS to a circuit switched network.

In step (c), the mobile 701 initiates a user plane (UP) event location report to the serving User Plane Location Server 705. The User Plane Location Server 705 stores its access network information to records associated with the IMS emergency call.

In step (d), the PSAP 707 generates a request for an updated location of the IMS emergency caller.

In step (e), based on the cached access network information associated with the IMS emergency call, and on a mapping of the service coverage of individual circuit switched location servers (Gateway Mobile Location Center (GMLC)/Mobile Positioning Center (MPC)), and access network information, the original User Plane Location Server/LRF 705 then initiates a location request for updated location of the IMS emergency caller 701 to the currently serving Gateway Mobile Location Center (GMLC)/Mobile Positioning Center (MPC) 711.

In step (f) of FIG. 2, the serving GMLC/MPC 711 initiates a control plane (CP) location service procedure to retrieve updated location information regarding a current location of the IMS emergency caller.

Related technologies are disclosed in co-owned and co-pending U.S. Provisional Application No. 61/213,084, entitled “Multiple Location Retrieval Function (LRF) Network Having Location Continuity” to Yinjin Zhu, filed May 5, 2009, the entirety of which is explicitly incorporated herein by reference.

While the invention has been described with reference to the exemplary embodiments thereof, those skilled in the art will be able to make various modifications to the described embodiments of the invention without departing from the true spirit and scope of the invention.

What is claimed is:

1. A method of maintaining continuity of location information relating to an IMS emergency caller during their IMS emergency call, comprising:
triggering, during an Internet Protocol Multimedia Subsystem (IMS) emergency call, a request to a location service based on an occurrence of a handover of an IMS emergency calling mobile device;
initiating from a physical user plane location server, a user plane positioning request; and
obtaining, during said IMS emergency call, an updated location of said IMS emergency call after said handover.

2. The method of maintaining continuity of location information relating to an IMS emergency caller during their IMS emergency call according to claim 1, wherein:
said physical user plane location server triggers said request to said location service.

3. The method of maintaining continuity of location information relating to an IMS emergency caller during their IMS emergency call according to claim 1, further comprising:
requiring said IMS emergency calling mobile device to report its access network information to said serving user plane location server.

4. The method of maintaining continuity of location information relating to an IMS emergency caller during their IMS emergency call according to claim 3, further comprising:
storing said reported access network information to a record associated with said IMS emergency call.

5. The method of maintaining continuity of location information relating to an IMS emergency caller during their IMS emergency call according to claim 1, further comprising:
responding to a request for said updated location from a public safety answering point (PSAP) with said obtained updated location.

6. A method of keeping track of updated location information relating to an IMS emergency caller during handover, comprising:
mapping access network information relating to a mobile Internet Protocol Multimedia Subsystem (IMS) emergency calling device;
maintaining coverage information relating to a plurality of location servers; and
associating a currently serving location server with an updated location of said IMS emergency caller as said IMS emergency caller changes location during a given IMS emergency call.

7. The method of keeping track of updated location information relating to an IMS emergency caller during handover according to claim 6, wherein:
said location server is a user plane location server.

8. The method of keeping track of updated location information relating to an IMS emergency caller during handover according to claim 6, wherein:
said location server is a control plane location server.
